(19) United States
(12) Patent Application Publication
(10) Pub. No.: US 2024/0032118 A1
(43) Pub. Date: Jan. 25, 2024

(54) WIRELESS COMMUNICATION METHOD, MOVABLE PLATFORM, SYSTEM, AND COMPUTER-READABLE STORAGE MEDIA

(71) Applicant: SZ DJI TECHNOLOGY CO., LTD., Shenzhen (CN)

(72) Inventors: Liyu WU, Shenzhen (CN); Xiaojun YIN, Shenzhen (CN); Ning MA, Shenzhen (CN)

(73) Assignee: SZ DJI TECHNOLOGY CO., LTD., Shenzhen (CN)

(21) Appl. No.: 18/374,665

(22) Filed: Sep. 29, 2023

Related U.S. Application Data
(63) Continuation of application No. PCT/CN2021/084134, filed on Mar. 30, 2021.

(51) Int. Cl. H04W 76/10

(52) U.S. Cl. CPC H04W 76/10; H04W 84/005

(57) ABSTRACT

A wireless communication method may be applied to a movable platform. The movable platform and a terminal device can establish at least two wireless communication links between the movable platform and the terminal device, the at least two wireless communication links being configured to transmit image data captured by the movable platform to the terminal device. The method may include obtaining channel parameters of the at least two established wireless communication links, wherein the at least two established wireless communication links may comprise at least one public network communication link; and encoding the image data captured by the movable platform according to the channel parameters and sending the encoded image data to the terminal device over the at least two wireless communication links.

### CROSS-REFERENCE TO RELATED APPLICATION

The present application is a continuation of International Application No. PCT/CN2021/0841341, filed Mar. 30, 2021, the entire contents of which being incorporated herein by reference in its entirety.

### TECHNICAL FIELD

The present application relates to the field of data transmission and, in particular, to a wireless communication method, a movable platform, a system and a computer-readable storage medium.

### BACKGROUND

Currently, the wireless communication link between a movable platform and a terminal device is mainly realized based on a point-to-point private communication method. Taking a UAV as an example of the movable platform, most of the wireless communication links between the UAV and the terminal equipment are realized based on Software Defined Radio (SDR) in the existing technology. Although, the private communication method has the advantage of low latency, the operating frequency band of the private communication method is ISM band, which is prone to interference, so it is difficult to satisfy the user's increasing requirements for multiple performance indicators such as latency, image transmission quality and communication reliability using this single wireless communication method, and the user experience is not good.

### SUMMARY

Based on this, some embodiments of the present application provide a wireless communication method, a movable platform, a system, and a computer-readable storage medium designed to improve the reliability and efficiency of data transmission.

In a first aspect, some embodiments of the present application provide a wireless communication method applied to a movable platform, the movable platform being capable of establishing at least two wireless communication links between the movable platform and a terminal device, the at least two wireless communication links being configured for transmitting image data captured by the movable platform to the terminal device, the method may comprise:
obtaining channel parameters of at least two established wireless communication links, wherein the at least two established wireless communication links comprise at least one public network communication link; and
encoding the image data captured by the movable platform according to the channel parameters and sending the encoded image data to the terminal device over the at least two wireless communication links.

In a second aspect, some embodiments of the present application also provide a movable platform, the movable platform being capable of establishing at least two wireless communication links between the movable platform and a terminal device, the at least two wireless communication links being configured for transmitting image data captured by the movable platform to the terminal device, the movable platform comprising at least two wireless communication devices, a memory and a processor;
the at least two wireless communication devices are configured to establish at least two wireless communication links between the movable platform and the terminal device;
the memory is configured to store a computer program;
the processor for executing the computer program and, in executing the computer program, implementing the following steps:
obtaining channel parameters of at least two established wireless communication links, wherein the at least two established wireless communication links comprise at least one public network communication link; and
encoding the image data captured by the movable platform according to the channel parameters and sending the encoded image data to the terminal device over the at least two wireless communication links.

In a third aspect, some embodiments of the present application also provide a communication system wherein the communication system comprises a terminal device and a movable platform according to one embodiment of the present application, the movable platform being capable of establishing at least two wireless communication links with the terminal device, the at least two wireless communication links being configured to transmit image data captured by the movable platform to the terminal device.

In a fourth aspect, some embodiments of the present application further provide a non-transitory computer-readable storage medium, the computer-readable storage medium storing a computer program, the computer program when executed by a processor causing the processor to implement a wireless communication method according to one embodiment to the present application.

Some embodiments of the present application provide a wireless communication method, a movable platform, a system, and a computer-readable storage medium, in which by obtaining channel parameters of at least two established wireless communication links, and the at least two established wireless communication links include at least one public network communication link, and then encoding image data captured by the movable platform according to the channel parameters, and through the at least two wireless communication links, the encoded image data is sent to the terminal device, which can greatly improve the reliability and efficiency of data transmission.

It should be understood that the above general description and the following detailed description are only exemplary and explanatory and are not restrictive of the present disclosure.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 is a schematic diagram of a scenario for implementing a wireless communication method provided by some embodiments of the present application;

FIG. 2 is a schematic flowchart of steps of a wireless communication method provided by some embodiments of the present application;

FIG. 3 is a schematic flowchart of sub-steps of the wireless communication method of FIG. 2;

FIG. 4 is a schematic diagram of one of two wireless communication links transmitting image data in an embodiment of the present application;

FIG. 5 is another schematic diagram of two wireless communication links transmitting image data in an embodiment of the present application;

FIG. 6 is another schematic diagram of two wireless communication links transmitting image data in an embodiment of the present application;

FIG. 7 is another schematic diagram of two wireless communication links transmitting image data in an embodiment of the present application;

FIG. 8 is a schematic flowchart of sub-steps of the wireless communication method of FIG. 2;

FIG. 9 is a schematic block diagram of a structure of a movable platform provided by some embodiments of the present application;

FIG. 10 is a schematic block diagram of a structure of a communication system provided by some embodiments of the present application.

### DETAILED DESCRIPTION

The technical solutions in the embodiments of the present application will be described in the following in conjunction with the accompanying drawings in the embodiments of the present application, and it is obvious that the described embodiments are a part of the embodiments of the present application and not all of the embodiments. Based on the embodiments in this application, all other embodiments obtained by a person of ordinary skill in the art without making creative labor fall within the scope of protection of this application.

The flowchart shown in the accompanying drawings is only an example illustration and is not necessary to include all contents and operations/steps, nor is it necessary to perform them in the order depicted. For example, some of the operations/steps may also be decomposed, combined or partially merged, and thus the actual order of execution may change depending on the actual situation.

Some embodiments of the present application are described in detail below in conjunction with the accompanying drawings. The following embodiments and features in the embodiments may be combined with each other without conflict.

Currently, the wireless communication link between a movable platform and a terminal device is mainly realized based on a point-to-point private communication method. Taking a UAV as an example of the movable platform, most of the wireless communication links between the UAV and the terminal equipment are realized based on Software Defined Radio (SDR) in the existing technology. Although the private communication method has the advantage of low latency, the operating frequency band of the private communication method is ISM band, which is prone to interference. Thus, it is difficult to satisfy the user's increasing requirements for multiple performance indicators such as latency, image transmission quality and communication reliability using this single wireless communication method, and the user experience is not good.

To solve the above or other problems, some embodiments of the present application provide a wireless communication method, a movable platform, a system, and a computer-readable storage medium, in which by obtaining channel parameters of at least two established wireless communication links, and the at least two established wireless communication links include at least one public network communication link, and then encoding image data captured by the movable platform based on the channel parameters and sending the encoded image data to a terminal device via the at least two wireless communication links, which can greatly improve the reliability and efficiency of data transmission.

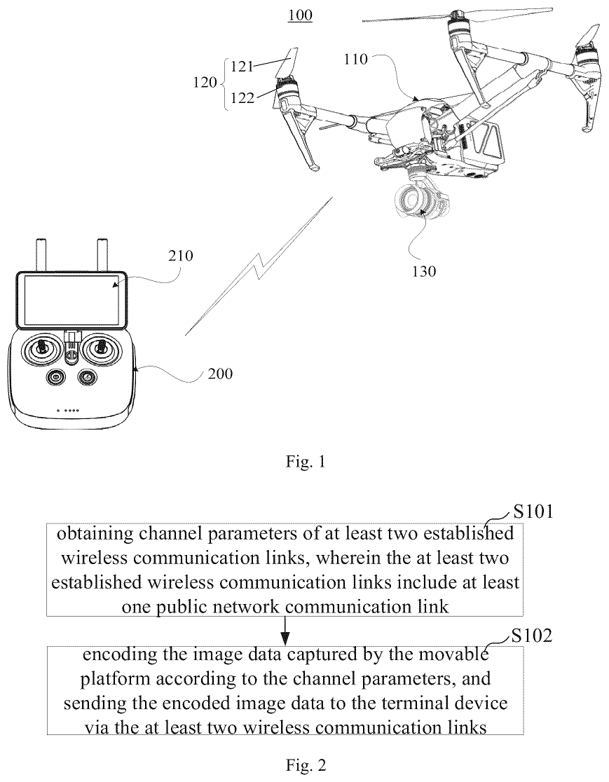

Referring to FIG. 1, FIG. 1 is a schematic diagram of a scenario for implementing a wireless communication method provided by some embodiments of the present application. As shown in FIG. 1, the scenario includes a movable platform 100 and a terminal device 200, the movable platform 100 and the terminal device 200 are capable of establishing at least two wireless communication links between the movable platform 100 and the terminal device 200, the at least two wireless communication links are used for transmitting image data captured by the movable platform 100 to the terminal device 200, and the at least two wireless communication links that have been established include at least one public network communication link. The terminal device 200 is used to control the movable platform 100. The movable platform 100 comprises a platform body 110, a power system 120 disposed on the platform body 110, a filming device 130, at least two wireless communication devices, and a control system, the power system 120 being used to provide the movable platform 100 with moving power, and the filming device 130 for capturing image data.

In an embodiment, the movable platform 100 includes at least two wireless communication devices. The at least two wireless communication devices included in the movable platform 100 include a first wireless communication device and a second wireless communication device. The terminal device 200 also includes at least two wireless communication devices, the at least two wireless communication devices included in the terminal device 200 include a third wireless communication device and a fourth wireless communication device. The first wireless communication device and the third wireless communication device are used for establishing the first wireless communication link between the movable platform 100 and the terminal device 200, and the second wireless communication device and the fourth wireless communication device are used to establish the second wireless communication link between the movable platform 100 and the terminal device 200.

In one embodiment, the first wireless communication link may be a public network communication link and the second wireless communication link may be a private network communication link, or the first wireless communication link may be a private network communication link and the second wireless communication link may be a public network communication link. The public network communication link is a wireless communication link established based on the public network communication, and the private network communication link is a wireless communication link established based on the private communication. The public communications include, but are not limited to, 4G communications, 5G communications, and 6G communications, and the private communications include, but are not limited to, Software Defined Radio (SDR) based Lightbridge and Ocusync, among others.

In an embodiment, the power system 120 may include one or more propellers 121, one or more motors 122 corresponding to the one or more propellers, and one or more electronic governors. Wherein, the motor 122 is connected between the electronic governor and the propellers 121, and the motor 122 and the propellers 121 are provided on the platform body 110 of the movable platform 100; the electronic governor is used to receive a drive signal generated by the control system and provide a drive current to the motor 122 according to the drive signal to control the rotational speed of the motor 122. The motor 122 is used to drive the propeller 121 to rotate, thereby providing power for movement of the movable platform 100, which power enables the movable platform 100 to realize one or more degrees of freedom of movement. In some embodiments, the movable platform 100 may rotate about one or more rotational axes. For example, the rotational axis may include a roll axis, a yaw axis, and a pitch axis. It should be understood that the motor 122 may be a DC motor or an AC motor. Alternatively, the motor 122 may be a brushless motor or a brushed motor.

Among other things, the control system may include a processor and a sensing system. The sensing system is used to measure attitude information of the movable platform, i.e., position information and state information of the movable platform 100 in space, such as a three-dimensional position, a three-dimensional angle, a three-dimensional velocity, a three-dimensional acceleration, and a three-dimensional angular velocity. The sensing system may, for example, include at least one of sensors such as gyroscopes, ultrasonic sensors, an electronic compass, an inertial measurement unit (IMU), vision sensors, a global navigation satellite system (GNSS), and a barometer. For example, the global navigation satellite system may be the Global Positioning System (GPS). The processor is used to control movement of the movable platform 100, for example, the movement of the movable platform 100 may be controlled based on attitude information measured by the sensing system. It should be understood that the processor may control the movable platform 100 in accordance with pre-programmed instructions.

In an embodiment, the processor is used to obtain channel parameters of the established at least two wireless communication links; and encode the image data captured by the movable platform 100 according to the channel parameters, and send the encoded image data to the terminal device 200 via the at least two wireless communication links. The movable platform 100 may comprise a drone, an unmanned vehicle, a manned vehicle, a manned aircraft, and a movable robot. The drone may comprise a rotary-wing type drone, for example, a single-rotor drone, a dual-rotor drone, a quad-rotor drone, a six-rotor drone, an octo-rotor drone, a fixed-wing drone, and a combination of a rotary-wing type and a fixed-wing drone, which will not be limited herein.

In an embodiment, the terminal device 200 includes a display device 210, and the terminal device 200 displays image data sent by the movable platform 100 for viewing by the user via the display device 210. It is noted that the display device 210 includes a display screen provided on the terminal device 200 or a display independent of the terminal device 200, and the display independent of the terminal device 200 may include a cellular phone, a tablet computer or a personal computer, etc., or may also be other electronic devices with a display screen. Among them, the display screen includes an LED display screen, an OLED display screen, an LCD display screen, and the like.

Among other things, the terminal device 200 may include, but is not limited to: a smart phone/cell phone, a tablet computer, a personal digital assistant (PDA), a desktop computer, a media content player, a video gaming station/system, a virtual reality system, an augmented reality system, a wearable device (e.g., a watch, eyeglasses, gloves, a headgear (e.g., a hat, a helmet, a virtual reality headset, an augmented reality headset, head mounted device (HMD), headband, pendant, armband, leg ring, shoe, vest), gesture recognition device, microphone, any electronic device capable of providing or rendering image data, or any other type of device. The terminal device 200 may be a handheld terminal, and the terminal device 200 may be portable. The terminal device 200 may be carried by a human user. In some instances, the terminal device 200 may be remote from the human user and the user may use wireless and/or wired communications to control the terminal device 200.

In an embodiment, the wireless communication method provided in the present application may also be applied to image transmission between a movable platform and a movable platform (e.g., video transmission between two manned vehicles), image transmission between a terminal device and a terminal device (e.g., a video call), image transmission between a surveillance camera and a terminal device, and so on, for which the present application does not make any specific limitation.

Hereinafter, the wireless communication method provided by some embodiments of the present application will be described in detail in connection with the scene in FIG. 1. It is to be noted that the scene in FIG. 1 is only used to explain the wireless communication method provided by the embodiments of the present application, but does not constitute a limitation of the application scene of the wireless communication method provided by the embodiments of the present application.

Referring to FIG. 2, FIG. 2 is a schematic flowchart of steps of a wireless communication method provided by some embodiments of the present application. The wireless communication method may be applied to a movable platform for improving the reliability and efficiency of data transmission between the movable platform and a terminal device.

As shown in FIG. 2, the wireless communication method may include steps S101 through S102.

Step S101, obtaining channel parameters of at least two established wireless communication links, wherein the at least two established wireless communication links include at least one public network communication link.

Step S102, encoding the image data captured by the movable platform according to the channel parameters, and sending the encoded image data to the terminal device via the at least two wireless communication links.

In an embodiment, the at least two wireless communication links between the movable platform and the terminal device include at least one public network communication link and at least one private network communication link, the public network communication link is a wireless communication link established based on a public network communication, the private network communication link is a wireless communication link established based on a private communication, the public communication includes, but is not limited to, a 4G communication, a 5G communication, and a 6G communication, the private communication including, but not limited to, Software Defined Radio (SDR)-based Lightbridge and Ocusync, etc. The channel parameters of the wireless communication link may include the channel bandwidth of the wireless communication link, the received power of the reference signal, and/or the received signal-to-noise ratio. Sending the encoded image data to the terminal device through the public network communication link and the private network communication link can solve the signal masking problem in the point-to-point private communication, and can greatly improve reliability and efficiency of data transmission.

In an embodiment, in the process of the user controlling the movable platform via the terminal device, the terminal device, after receiving the first channel image data transmitted via the private network communication link, may decode the first channel image data in real time and display the first image data obtained by decoding, so as to enable the terminal device to display real-time graphic data and facilitate the user to control the movable platform. After receiving the second image data transmitted via the public network communication link, if the terminal device is in a live broadcast state, the second image data can be transmitted to a live broadcast platform, and the live broadcast platform distributes the second image data to user terminals that watch the live broadcast. By the above method, the reliability of the transmission of the real-time map transmission data can be ensured, and the picture quality of the live broadcast screen can also be ensured, which greatly improves the user experience.

In one embodiment, the movable platform comprises at least a first wireless communication device and a second wireless communication device, the terminal device also comprises at least two wireless communication devices, the terminal device comprises at least a third wireless communication device and a fourth wireless communication device, the first wireless communication device and the third wireless communication device are used to establish a first wireless communication link between the movable platform and the terminal device, the second wireless communication device and the fourth wireless communication device are used to establish a second wireless communication link between the movable platform and the terminal device.

In one embodiment, the first wireless communication link may be a public network communication link and the second wireless communication link may be a private network communication link, or the first wireless communication link may be a private network communication link and the second wireless communication link may be a public network communication link. The public network communication link is a wireless communication link established based on public network communication, and the private network communication link is a wireless communication link established based on private communication. A first transmission delay corresponding to the private network communication link is smaller than a second transmission delay corresponding to the public network communication link, and a first transmission data amount corresponding to the private network communication link is smaller than a second transmission data amount corresponding to the public network communication link.

In an embodiment, the at least two wireless communication links between the movable platform and the terminal device include a first public network communication link and a second public network communication link, and the network operator corresponding to the first public network communication link is different or the same as the network operator corresponding to the second public network communication link. Among them, the 4G network or the 5G network in the public network communication is mainly constructed by different network operators, for example, China Mobile and China Radio and Television share the common construction of a 5G network in the 700 MHz+2.6 GHz+4.9 GHz frequency band, with 700M for the wide-area coverage, 2.6G for the hotspot coverage, and 4.9G for the indoor coverage, which can satisfy the current demand of the To C as well as the future To B applications, while China Telecom and China Unicom share a common 5G network in the 2.1 GHz+3.5 GHz band, with the wireless side shared, the bearer network interoperable, the core network independent of each other, and support for TDD+FDD time-frequency dual aggregation. Due to the different wireless network bands deployed by each network operator, it is inevitable that the signals of China Mobile and China Radio and Television are good in some places, and the signals of China Telecom and China Unicom are good in some places, so it is difficult to adapt one operator to all wireless networks, and by connecting the networks of two different network operators, it can effectively cope with the problem of weak signals caused by the lack of optimization of a certain network operator's deployment. It can greatly improve the reliability of communication.

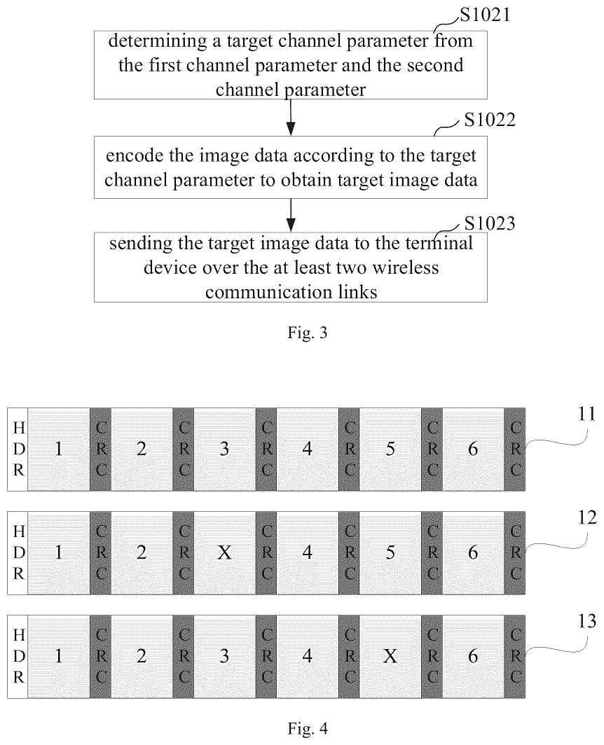

In an embodiment, as shown in FIG. 3, step S102 may include: sub-steps S1021 to S1023.

Sub-step S1021, determining a target channel parameter from the first channel parameter and the second channel parameter.

wherein the at least two wireless communication links include a first wireless communication link and a second wireless communication link, the channel parameter includes a first channel parameter of the first wireless communication link and a second channel parameter of the second wireless communication link, the first channel parameter includes any one of a first channel bandwidth or a first received signal-to-noise ratio, the second channel parameter includes any one of a second channel bandwidth or a second received signal-to-noise ratio, and the target channel parameter includes any one of a target channel bandwidth or a target received signal-to-noise ratio.

In an embodiment, if the first channel parameter is smaller than the second channel parameter, the first channel parameter is determined as the target channel parameter; if the first channel parameter is larger than the second channel parameter, the second channel parameter is determined as the target channel parameter. By determining a smaller one of the first channel parameter and the second channel parameter as the target channel parameter, the first wireless communication link and the second wireless communication link are able to transmit the encoded image data after subsequent encoding of the image data on the basis of the target channel parameter, reducing the occurrence of congestion in the communication link.

Exemplarily, if the first channel bandwidth is less than the second channel bandwidth, the first channel bandwidth is determined as the target channel bandwidth, and if the first channel bandwidth is greater than the second channel bandwidth, the second channel bandwidth is determined as the target channel bandwidth. Alternatively, if the first received signal-to-noise ratio is less than the second received signal-to-noise ratio, the first received signal-to-noise ratio is determined as the target received signal-to-noise ratio, and if the first received signal-to-noise ratio is greater than the second received signal-to-noise ratio, the second received signal-to-noise ratio is determined as the target received signal-to-noise ratio.

Sub-step S1022, encode the image data according to the target channel parameter to obtain target image data.

Exemplarily, a target coding rate is determined according to the target channel parameter; the image data is coded according to the target coding rate to obtain the target image data. Wherein, the movable platform stores a mapping relationship between the channel parameter and the coding rate, and according to the mapping relationship between the channel parameter and the coding rate and the target channel parameter, the target coding rate can be quickly determined. The larger the channel parameter is, the larger the coding code rate is, and the smaller the channel parameter is, the smaller the coding code rate is. The mapping relationship between the channel parameter and the coding rate can be set based on actual situation, and embodiments of this application do not specifically limit this. By dynamically adjusting the target coding rate through the target channel parameter, the bandwidth utilization rate of the wireless communication link can be improved.

Sub-step S1023, sending the target image data to the terminal device over the at least two wireless communication links.

After obtaining the target image data, the target image data is simultaneously sent to the terminal device via at least two wireless communication links, and the terminal device, after receiving the at least two encoded target image data, decodes the received target image data and performs a de-redundancy process on the image data obtained by decoding, and then displays or stores the de-redundancy processed image data.

In an embodiment, the target image data is packetized to obtain a plurality of data packets; the plurality of data packets are simultaneously sent to the terminal device via the first wireless communication link and the second wireless communication link. Sending the plurality of data packets to the terminal device simultaneously via the first wireless communication link and the second wireless communication link avoids loss of bytes during transmission resulting in retransmission of the entire target image data, and in the event that the data packet transmitted by one wireless communication link is lost or incorrect while the data packet transmitted by the other wireless communication link is correct, the complete image data can be recovered using the correct data packet, which greatly improves the reliability and efficiency of data transmission.

In an embodiment, a way of performing packetization processing on the target image data to obtain a plurality of data packets may be as follows: determining a target number of bits based on the target channel parameter; performing packetization processing on the target image data based on the target number of bits to obtain a plurality of data packets. Wherein, the movable platform stores a mapping relationship between the channel parameter and the number of bits of the data packets, and according to the mapping relationship and the target channel parameter, the target number of bits of the data packets can be determined. Each data packet carries a CRC check code, and the terminal device can check the received data packet by the CRC check code.

Exemplarily, as shown in FIG. 4, the target image data is divided into a first packet queue 11, the first packet queue 11 includes 6 packets, and each packet carries a CRC check code, and when the first wireless communication link transmits these 6 packets, the 3rd packet is lost or an error occurs, resulting in the absence of the 3rd packet in the second packet queue 12 transmitted by the first wireless communication link, and When the second wireless communication link transmits these 6 data packets, the 5th data packet is lost or an error occurs, resulting in no 5th data packet in the third data packet queue 13 transmitted by the second wireless communication link. When the terminal device receives both the second data packet queue 12 and the third data packet queue 13, it can recover from the second data packet queue 12 and the third data packet queue 13 to obtain the first data packet queue 11, improving data transmission reliability.

In an embodiment, a first number of bits is determined according to a first channel parameter, and the target image data is packetized according to the first number of bits to obtain a plurality of first packets; a second number of bits is determined according to a second channel parameter, and the target image data is packetized according to the second number of bits to obtain a plurality of second packets; and the plurality of first packets are sent to the terminal device via a first wireless communication link, and at the same time, the plurality of second data packets are sent to the terminal device via the second wireless communication link. Among them, the first bit number and the second bit number may or may not be the same, and the present application does not make specific limitations thereon.

It can be understood that the encoded transmission of the whole to zero can also be based on the byte order, and the size of the packet is completely determined by the two wireless communication links themselves. For example, the first wireless communication link is in accordance with one packet for every 1000 bytes, and the second wireless communication link is in accordance with one packet for every 4000 bytes, and the terminal device recovers the original data through the byte order. For example, the data received between the 1st byte and the 2000th byte of the first wireless communication link transmission can be recovered using the data between the 1st byte and the 4000th byte. That is, if the data between the 1000th byte and the 2000th byte transmitted by the first wireless communication link is received incorrectly, the data between the 1st byte and the 4000th byte transmitted by the second wireless communication link can be utilized to recover the data.

In an embodiment, the target image data is packetized to obtain a plurality of data packets; a first portion of the data packets in the plurality of data packets is sent to the terminal device via a first wireless communication link; and a second portion of the data packets in the plurality of data packets other than the first portion of the data packets is simultaneously sent to the terminal device via a second wireless communication link. Wherein the number of data packets in the first portion of data packets and the number of data packets in the second portion of data packets may be the same or different. By transmitting one portion of the data packets through one wireless communication link and simultaneously transmitting another portion of the data packets through another wireless communication link, data transmission efficiency and reliability can be improved.

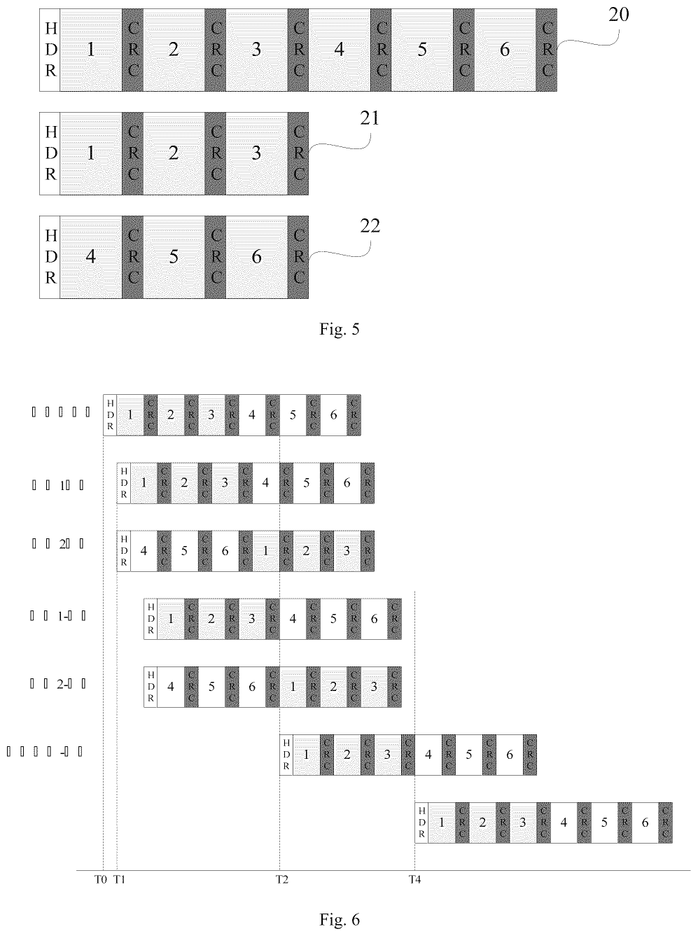

Exemplarily, as shown in FIG. 5, the target image data is divided into a packet queue 20, the packet queue 20 includes six packets, respectively packet 1, packet 2, packet 3, packet 4, packet 5, and packet 6, and each of the packets carries a CRC check code, and a first portion of the packet 21 is transmitted via a first wireless communication link, the first portion of the packet 21 includes data packet 1, data packet 2, and data packet 3, and transmitting a second portion of data packet 22 over a second wireless communication link, the second portion of data packet 22 comprising data packet 4, data packet 5, and data packet 6.

In an embodiment, after sending the first portion of the data packet and the second portion of the data packet, the second portion of the data packet is sent to the terminal device via the first wireless communication link, and the first portion of the data packet is sent to the terminal device via the second wireless communication link. By sending the second portion of the data packet to the terminal device via the first wireless communication link and sending the first portion of the data packet to the terminal device via the second wireless communication link after sending the first portion of the data packet and the second portion of the data packet, exchange transmission of the data packet is realized, and the reliability of the data transmission can be improved.

For example, as shown in FIG. 6, at the moment of T0, the movable platform splits the target image data into six packets, and at the moment of T1, the first transmission is started, i.e., link 1 sends packet 1, packet 2, and packet 3 to the terminal device, and link 2 sends packet 4, packet 5, and packet 6 to the terminal device; after the completion of transmission, the second transmission is opened, i.e., link 1 sends packet 4, packet 5, and packet 6, and link 2 sends packet 1, packet 2, and packet 3 to the terminal device; at the moment of T2, the terminal device receives the data sent by link 1 and link 2, and since the transmission delay of the two links is different, T2 takes the longest transmission delay as the standard. If there is no packet loss in the transmission process, the terminal device, at the moment of T2, in the time that it could only receive three packets previously will be able to receive the complete 6 data packets sent by the two links. Wherein, link 1 may be a first wireless communication link and link 2 may be a second wireless communication link.

If there is a packet loss during the first transmission, it means that the channel quality of the link on which the packet loss occurs is not high or there is interference, for example, link 1 does not successfully transmit packet 2. However, during the second transmission, link 1 and link 2 exchange the order of the transmitted packets, i.e., packet 2 will be transmitted on link 2, and the interference will not be too drastically changed in a short period of time. Therefore, the probability of the link 2 successfully transmitting packet 2 will increase, allowing the terminal device to receive the complete 6 packets sent by both links. In the worst case, at the moment of T4, the transmission of the packets of the two links is completed, and the terminal equipment can receive the complete six data packets.

In an embodiment, a first feedback information sent by the terminal device is obtained, and based on the first feedback information, it is determined whether an error occurs in the transmitted data packet; if an error occurs in the transmitted data packet, a second portion of the data packet is sent to the terminal device via the first wireless communication link; and at the same time, the first portion of the data packet is sent to the terminal device via the second wireless communication link. Wherein, if the first feedback information carries an error label, it can be determined that the transmitted data packet is in error, and if the first feedback information does not carry an error label, it can be determined that the transmitted data packet is not in error. By sending the second portion of the data packet to the terminal device via the first wireless communication link and at the same time sending the first portion of the data packet to the terminal device via the second wireless communication link when the transmitted data packet appears to be in error, exchange transmission of the data packet is realized, and the reliability of the data transmission can be improved.

In an embodiment, obtaining the first feedback information sent by the terminal device and determining, based on the first feedback information, whether an error occurs in the transmitted data packet; if an error occurs in the transmitted data packet, determining, based on the first feedback information, a packet to be retransmitted from a plurality of data packets; and if the packet to be retransmitted is located in a first portion of the data packet, retransmitting the packet to be retransmitted to the terminal device via the second wireless communication link; If the packet to be retransmitted is located in the second portion of the packet, retransmitting the packet to be retransmitted to the terminal device over the first wireless communication link. By retransmitting the lost packet through another wireless communication link when a packet loss occurs in one of the wireless communication links, the reliability and efficiency of data transmission can be improved.

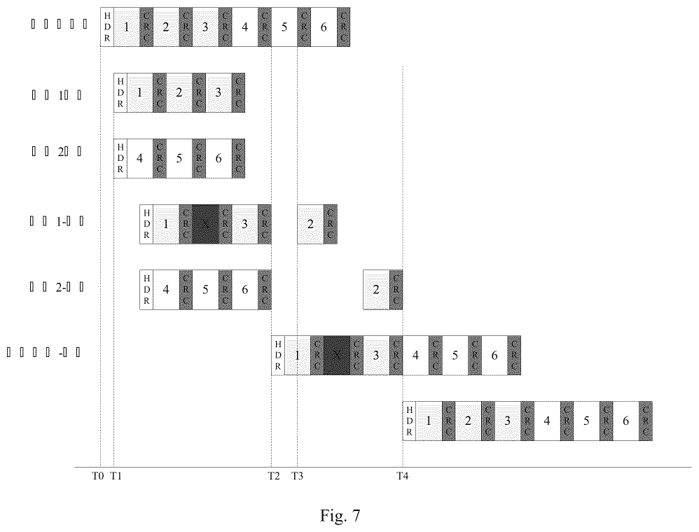

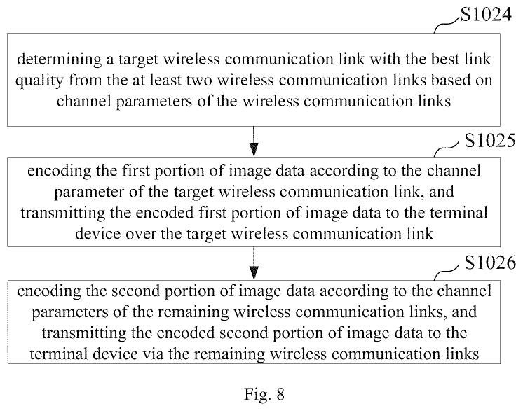

In one embodiment, as shown in FIG. 7, at the moment of T0, the movable platform splits the target image data into six data packets, and at the moment of T1, the first transmission is started, i.e., link 1 sends data packet 1, data packet 2 and data packet 3 to the terminal device, and link 2 sends data packet 4, data packet 5, and data packet 6 to the terminal device; at the moment of T2, the terminal device receives the data sent by link 1 and link 2. Since the transmission delay of the two links is different, T2 is based on the longest transmission delay; at the moment of T3, the terminal device sends a first feedback message to the movable platform, and through the first feedback message, it is known that the data packet 2 transmitted by the link 1 is not received, and it is requested to be retransmitted; the movable platform receives the feedback, and then retransmits the data packet 2 at the link 2; at the moment of T4, the terminal device receives the retransmitted data packet 2, and recovers the complete 6 data packets.

In an embodiment, as shown in FIG. 8, step S102 may include: sub-steps S1024 through S1026.

Sub-step S1024, determining a target wireless communication link with the best link quality from the at least two wireless communication links based on channel parameters of the wireless communication links.

In an embodiment, a link quality of each wireless communication link is determined based on a channel parameter of each wireless communication link; and the wireless communication link with the best link quality is selected as a target wireless communication link from the at least two wireless communication links. Wherein the determination of the link quality of the wireless communication links may be as follows: determining the link quality of each wireless communication link based on a channel bandwidth, a reference signal received power, a received signal-to-noise ratio, and/or a transmission delay of each wireless communication link.

It is to be understood that the higher the channel bandwidth, the reference signal received power and/or the received signal-to-noise ratio of the wireless communication link, and the lower the transmission delay, the better the link quality of the wireless communication link, and the lower the channel bandwidth, the reference signal received power and/or the received signal-to-noise ratio of the wireless communication link, and the higher the transmission delay, the worse the link quality of the wireless communication link.

Sub-step S1025, encoding the first portion of image data according to the channel parameter of the target wireless communication link, and transmitting the encoded first portion of image data to the terminal device over the target wireless communication link.

In an embodiment, a target coding rate is determined according to a channel bandwidth of a target wireless communication link; the first portion of image data is coded according to the target coding rate. Wherein, a mapping relationship between the channel bandwidth and the coding rate is stored in the movable platform, and the target coding rate can be determined based on the mapping relationship and the channel bandwidth of the target wireless communication link. The larger the channel bandwidth is, the larger the coding rate is, and the smaller the channel bandwidth is, the smaller the coding rate is. The mapping relationship between the channel bandwidth and the coding rate can be set based on the actual situation, and the embodiments of the application do not make specific limitations in this regard.

Sub-step S1026, encoding the second portion of image data according to the channel parameters of the remaining wireless communication links, and transmitting the encoded second portion of image data to the terminal device via the remaining wireless communication links.

Exemplarily, if the link quality of the first wireless communication link is best, the first portion of the image data is transmitted over the first wireless communication link, and the second portion of the image data is transmitted over the second wireless communication link; if the link quality of the second wireless communication link is best, the first portion of the image data is transmitted over the second wireless communication link, and the second portion of the image data is transmitted over the first wireless communication link.

Wherein the transmission priority of the first portion of image data is higher than the transmission priority of the second portion of image data. For example, the first portion of the image data is real-time graphic transmission data of the movable platform, and the second portion of the image data is a filmed video or picture that the user wishes to download. Transmitting the real-time graphic transmission data through the target wireless communication link with the best link quality, and transmitting the filmed video or picture that the user wishes to download through the rest of the wireless communication links, ensures that the real-time graphic transmission data is reliably received by the terminal device. The terminal device informs the user of the environment around the movable platform by displaying the real-time map transmission data, which facilitates the user in controlling the movable platform by means of the displayed real-time map transmission data and ensures the safety of the movable platform.

In an embodiment, obtaining second feedback information sent by the terminal device, and determining, based on the second feedback information, whether there is an error in the image data transmitted by the target wireless communication link; if there is an error in the image data transmitted by the target wireless communication link, determining, based on the second feedback information, image data to be retransmitted from the first portion of the image data; suspending the transmission of encoded second portion of image data to the terminal device through the rest of the wireless communication link and sending the image data to be retransmitted to the terminal device through the remaining wireless communication links; after the transmission of the image data to be retransmitted is completed, continue sending the encoded second portion of the image data to the terminal device through the remaining wireless communication links. In the event of an error in the image data transmitted by the target wireless communication link, the image data in error is transmitted through the remaining wireless communication links, so that the terminal device can quickly recover the complete image data based on the retransmitted image data, and the continuity of the transmission can also be ensured, which greatly improves the reliability and efficiency of data transmission.

In an embodiment, a target wireless communication link with the best link quality is determined from at least two wireless communication links according to the channel parameters of each wireless communication link; the image data captured by the movable platform is encoded according to the channel parameters of the target wireless communication link; and the encoded image data is transmitted to the terminal device simultaneously via the at least two wireless communication links. Encoding the image data via the channel parameters of the wireless communication link with the best link quality ensures the utilization rate of the wireless communication link with the best link quality, and at the same time transmitting the same image data via the remaining wireless communication links improves the reliability and efficiency of the data transmission.

Exemplarily, if the link quality of the first wireless communication link is best, the image data captured by the movable platform is encoded according to the first channel parameter of the first wireless communication link; the encoded image data is sent to the terminal device via the first wireless communication link and the second wireless communication link simultaneously. If the link quality of the second wireless communication link is the best, the image data captured by the movable platform is encoded according to the second channel parameters of the second wireless communication link; and the encoded image data is simultaneously sent to the terminal device via the first wireless communication link and the second wireless communication link.

In an embodiment, obtaining third feedback information sent by the terminal device, and determining whether an error occurs in the image data transmitted by the target wireless communication link based on the third feedback information; if an error occurs in the image data transmitted by the target wireless communication link, determining, based on the third feedback information, the image data to be retransmitted; suspending transmitting the encoded image data to the terminal device through the rest of the wireless communication link; transmitting the image data to be retransmitted to the terminal device through the rest of the wireless communication links to send the image data to be retransmitted to the terminal device; after the transmission of the image data to be retransmitted is completed, continuing to send the encoded image data to the terminal device through the remaining wireless communication links. When an error occurs in the image data transmitted by the target wireless communication link, the error image data is transmitted through the remaining wireless communication links, so that the terminal equipment can quickly recover the complete image data based on the retransmitted image data, and the continuity of the transmission can also be ensured, which greatly improves the reliability and efficiency of data transmission.

Exemplarily, if the link quality of the first wireless communication link is the best, when there is an error in the image data transmitted by the first wireless communication link, the sending of the encoded image data to the terminal device via the second wireless communication link is suspended and the image data to be retransmitted is sent to the terminal device via the second wireless communication link; and after the image data to be retransmitted is sent, continue to send the encoded image data to the terminal device through the second wireless communication link.

In an embodiment, obtaining a link quality change trend of a target wireless communication link; selecting a target channel bandwidth from channel bandwidths of at least two wireless communication links based on the link quality change trend; encoding image data captured by the movable platform based on the target channel bandwidth; and transmitting the encoded image data to the terminal device via the at least two wireless communication links simultaneously. The channel bandwidth can be dynamically determined based on the link quality change trend of the target wireless communication link, and after the image data is encoded based on the channel bandwidth, the encoded image data are all capable of being transmitted by the at least two wireless communication links at the same time, which can improve the reliability and efficiency of the data transmission.

In an embodiment, if the link quality change trend does not satisfy the preset link quality degradation condition, a channel bandwidth of the target wireless communication link is determined as the target channel bandwidth; and if the link quality change trend satisfies the preset link quality degradation condition, a channel bandwidth of the remaining wireless communication link is determined as the target channel bandwidth. Wherein the link quality degradation condition comprises the degraded link quality gain being greater than the link quality degradation threshold. In the above manner, it is possible to transmit image data simultaneously over two wireless communication links when the link quality of the target wireless communication link deteriorates sharply, and the encoding rate takes the bandwidth that the two wireless communication links can transmit simultaneously as a reference.

For example, if the link quality of the first wireless communication link is the best, the channel bandwidth of the first wireless communication link is determined as the target channel bandwidth when the link quality change trend of the first wireless communication link does not satisfy the preset link quality degradation condition. When the link quality change trend of the first wireless communication link meets the preset link quality degradation condition, the channel bandwidth of the second wireless communication link is determined as the target channel bandwidth.

In an embodiment, obtaining a link quality of the established first wireless communication link; if the link quality of the first wireless communication link is less than or equal to a predetermined threshold, establishing the remaining wireless communication links between the movable platform and the terminal device to obtain at least two wireless communication links; obtaining channel parameters of the established at least two wireless communication links, wherein the established at least two wireless communication links comprise at least one public network communication link; encoding the image data captured by the movable platform according to the channel parameters, and sending the encoded image data to the terminal device via the at least two wireless communication links. When the link quality of the established first wireless communication link is poor, establishing the remaining wireless communication links and sending the encoded image data through the at least two wireless communication links may improve the reliability and efficiency of data transmission.

In an embodiment, if the link quality of the first wireless communication link is greater than a preset threshold, the image data captured by the movable platform is encoded according to the channel parameter of the first wireless communication link; and the encoded image data is sent to the terminal device via the first wireless communication link. By not establishing the remaining wireless communication links when the link quality of the first wireless communication link is good, and only sending the image data to the terminal device via the first wireless communication link, the reliability of data transmission can be ensured while power consumption is reduced.

In an embodiment, after at least two wireless communication links are established, if the link quality of the first wireless communication link changes from being less than or equal to a predetermined threshold to being greater than the predetermined threshold, disconnect the remaining wireless communication links; encode the image data captured by the movable platform in accordance with the channel parameter of the first wireless communication link; and send the encoded image data to the terminal device via the first wireless communication link. By disconnecting the remaining wireless communication links after the link quality of the first wireless communication link changes from poor to good, and only sending the image data to the terminal device via the first wireless communication link, the reliability of data transmission can be ensured while power consumption is reduced.

In an embodiment, obtaining a first error-tolerant frame acquisition request sent by an intermediate node of a non-point-to-point wireless communication link; according to the first error-tolerant frame acquisition request, intra-frame encoding is performed on the image data captured by the movable platform to obtain an error-tolerant frame; and the error-tolerant frame is sent to the terminal device through any one of the wireless communication links, or the error-tolerant frame is sent to the terminal device through the wireless communication link with the best link quality, or sending the error-tolerant frame to the terminal device through at least two wireless communication links simultaneously. Wherein the at least two wireless communication links include non-point-to-point wireless communication links, the non-point-to-point wireless communication links may be public network communication links, the public network communication links may also be point-to-point wireless communication links, and the non-point-to-point wireless communication links include at least one intermediate node, which may be a server or a base station. By sending the fault-tolerant frame acquisition request sent by the intermediate node of the wireless communication link, the fault-tolerant frame is sent by the movable platform to the terminal device, which may help the terminal device to quickly recover the picture based on the fault-tolerant frame.

For example, in a UAV mapping system, the encoded image data from the UAV is transmitted to the remote controller via the downlink, and the remote controller gives feedback to the UAV based on the received data; if there is a frame loss during the transmission process, it needs to be notified to the encoder of the UAV via the uplink to request the UAV to send an error-tolerant frame (I-frame), so as to allow the remote controller to resume the subsequent decoding normally.

If there is a non-point-to-point wireless communication link between the UAV and the remote controller, since the non-point-to-point wireless communication link includes two separate links, data upload (the UAV uploads data to the intermediate node) and data download (the intermediate node downloads data uploaded by the UAV and sends it to the remote controller), frames may be lost on both links during transmission. If a packet loss occurs during the data upload from the UAV to the intermediate node, in this case, even if the data with packet loss is transmitted to the remote controller, the remote controller will not be able to correctly decode and display the data, and will have to re-initiate a request for a fault-tolerant frame acquisition.

However, at this time, the remote controller sends the request for error-tolerant frame acquisition to the intermediate node, which then sends the request for error-tolerant frame acquisition to the UAV, and after the encoder of the UAV receives the request, it will take a longer time to re-encode. During this period, because of packet loss in the middle, the decoder on the remote controller is unable to finish decoding and displaying all the subsequent data, and the screen will lag, which seriously affects the user experience. To alleviate this phenomenon, when the intermediate link has already detected a packet loss, or the link quality deteriorates or congestion occurs, it can take the initiative to initiate a fault-tolerant frame acquisition request to the UAV, instead of waiting for the remote controller to initiate a fault-tolerant frame acquisition request to the UAV after detecting a packet loss, which reduces the waiting time, thus contributing to the rapid recovery of the picture.

In an embodiment, if the second error-tolerant frame acquisition request sent by the terminal device is acquired, a first moment recorded by the movable platform receiving the first error-tolerant frame acquisition request is acquired; a second moment recorded by the movable platform receiving the second error-tolerant frame acquisition request is acquired, and a reception time difference is determined based on the first moment and the second moment; if the reception time difference is less than or equal to a preset time difference, no response is made to the second error-tolerant frame acquisition request. Among them, the preset time difference may be set based on the actual situation, and the embodiments of the present application do not make specific limitations in this regard.

In a point-to-point wireless communication link, although the intermediate node actively sends an error-tolerant frame acquisition request to the movable platform, the intermediate node still transmits incomplete data to the terminal device, and the terminal device also sends an error-tolerant frame acquisition request to the movable platform when it receives the incomplete data. In order to avoid frequent sending of error-tolerant frames to the terminal device, the time difference between the two sending of the error-tolerant frame acquisition request can be recorded, and when the time difference is less than or equal to the preset time difference, no response is made to the new error-tolerant frame acquisition request.

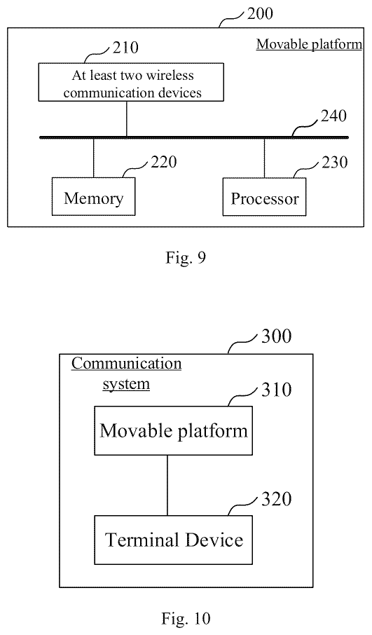

Referring to FIG. 9, FIG. 9 is a schematic block diagram of a structure of a movable platform provided by embodiments of the present application.

As shown in FIG. 9, the movable platform 200 includes at least two wireless communication devices 210, a memory 220, and a processor 230, and the at least two wireless communication devices 210, the memory 220, and the processor 230 are connected via a bus 240, which is, for example, an I2C (Inter-integrated Circuit) bus.

Optionally, the at least two wireless communication devices 210 are used to establish at least two wireless communication links between the movable platform 200 and the terminal device, and the at least two wireless communication links are used to transmit the image data captured by the movable platform 200 to the terminal device.

Optionally, the memory 220 may be a Flash chip, a read-only memory (ROM, Read-Only Memory) disk, a CD-ROM, a USB flash drive, or a removable hard drive, among others.

Optionally, the processor 230 may be a circuitry, a Micro-controller Unit (MCU), a Central Processing Unit (CPU), or a Digital Signal Processor (DSP), among others.

In some embodiments, the processor 220 is used to run a computer program stored in memory 230 and to implement the following steps in executing the computer program:
obtaining channel parameters of at least two established wireless communication links, wherein the at least two established wireless communication links comprise at least one public network communication link; and
encoding the image data captured by the movable platform according to the channel parameters and sending the encoded image data to the terminal device over the at least two wireless communication links.

In an embodiment, the at least two wireless communication links comprise at least one public network communication link and at least one private network communication link, the public network communication link being a wireless communication link established based on public network communication, and the private network communication link being a wireless communication link established based on private communication.

In an embodiment, the first transmission delay corresponding to the private network communication link is less than the second transmission delay corresponding to the public network communication link, and the first amount of transmitted data corresponding to the private network communication link is less than the second amount of transmitted data corresponding to the public network communication link.

In an embodiment, the at least two wireless communication links comprise a first public network communication link and a second public network communication link, the first public network communication link corresponding to a different or the same network operator as the second public network communication link.

In an embodiment, the at least two wireless communication links comprise a first wireless communication link and a second wireless communication link, the channel parameters comprise a first channel parameter of the first wireless communication link and a second channel parameter of the second wireless communication link, and the processor, in realizing encoding image data captured by the movable platform according to the channel parameters and sending the encoded image data to the terminal device via the at least two wireless communication links for realizing sending the encoded image data to the terminal device, is configured for:
determining a target channel parameter from the first channel parameter and the second channel parameter;
encoding the image data according to the target channel parameters to obtain target image data; and
sending the target image data to the terminal device over the at least two wireless communication links.

In an embodiment, the processor is used in realizing the determination of a target channel parameter from the first channel parameter and the second channel parameter:
If the first channel parameter is less than the second channel parameter, then the first channel parameter is identified as a target channel parameter;
If the first channel parameter is greater than the second channel parameter, then the second channel parameter is identified as a target channel parameter.

In an embodiment, the processor is configured to, in realizing the encoding of the image data according to the target channel parameters to obtain target image data:
determine a target coding rate based on the target channel parameter; and
coding the image data according to the target coding rate to obtain target image data.

In an embodiment, the processor is configured to, in realizing the sending of the target image data to the terminal device over the at least two wireless communication links:
obtain a plurality of packets by performing a packetization process on the target image data; and
send the plurality of data packets to the terminal device simultaneously over the first wireless communication link and the second wireless communication link.

In an embodiment, the processor is configured to, in realizing the packetization of the target image data to obtain a plurality of packets:
determine a target number of bits based on the target channel parameter; and
obtain the plurality of packets by packetizing the target image data according to the target number of bits.

In an embodiment, the processor is configured to, in realizing the sending of the target image data to the terminal device over the at least two wireless communication links:
determine a first number of bits based on the first channel parameter and perform packetization of the target image data based on the first number of bits to obtain a plurality of first packets;
determine a second number of bits based on the second channel parameter and perform packetization of the target image data based on the second number of bits to obtain a plurality of second packets; and
send the plurality of first data packets to the terminal device over the first wireless communication link while send the plurality of second data packets to the terminal device over the second wireless communication link.

In an embodiment, the processor is configured to, in realizing the sending of the target image data to the terminal device over the at least two wireless communication links:
obtain a plurality of packets by performing a packetization process on the target image data;
send a first portion of the plurality of data packets to the terminal device over the first wireless communication link; and
simultaneously send a second portion of the plurality of data packets other than the first portion of data packets to the terminal device over the second wireless communication link.

In an embodiment, the processor is further configured to realize the following steps:
obtaining first feedback information sent by the terminal device and determining whether an error has occurred in a transmitted data packet based on the first feedback information;
if there is an error in the transmitted packet, sending the second portion of the packet to the terminal device over the first wireless communication link while sending the first portion of the packet to the terminal device over the second wireless communication link.

In an embodiment, the processor is further used to realize the following steps:
obtaining first feedback information sent by the terminal device and determining whether an error has occurred in a transmitted data packet based on the first feedback information;
if an error occurs in the transmitted packet, the packet to be retransmitted is determined from the plurality of packets based on the first feedback information;
if the packet to be retransmitted is located in the first portion of the packet, retransmitting the packet to be retransmitted to the terminal device over the second wireless communication link; and
if the packet to be retransmitted is located in the second portion of the packet, retransmitting the packet to be retransmitted to the terminal device over the first wireless communication link.

In an embodiment, the image data comprises a first portion of image data and a second portion of image data, which the processor is configured to, in realizing the encoding of the image data captured by the movable platform in accordance with the channel parameters and the sending of the encoded image data to the terminal device over the at least two wireless communication links:
determine a target wireless communication link with the best link quality from the at least two wireless communication links based on a channel parameter of each the wireless communication link;
encode the first portion of image data according to the channel parameter of the target wireless communication link, and transmit the encoded first portion of image data to the terminal device over the target wireless communication link;
encode the second portion of image data according to the channel parameters of the remaining wireless communication links, and transmit the encoded second portion of image data to the terminal device over the remaining wireless communication links.

In an embodiment, the first portion of image data is transmitted with a higher priority than the second portion of image data.

In an embodiment, the processor is configured to, in realizing the encoding of the first portion of image data according to the channel parameter of the target wireless communication link:
determine a target coding rate based on a channel bandwidth of the target wireless communication link; and
encode the first portion of image data according to the target encoding rate.

In an embodiment, the processor is configured to, in realizing a target wireless communication link with the best link quality from the at least two wireless communication links based on the channel parameter of each the wireless communication link:
determine a link quality of each wireless communication link based on channel parameter of each wireless communication link; and
select the wireless communication link with the best link quality from the at least two wireless communication links as a target wireless communication link.

In an embodiment, the determining a link quality of each wireless communication link based on the channel parameter of each wireless communication link, comprising:

determining a link quality of each wireless communication link based on a channel bandwidth, a reference signal received power, a received signal-to-noise ratio and/or a transmission delay of each wireless communication link.

In an embodiment, the processor is further configured to realize the following steps:
obtaining second feedback information sent by the terminal device and determining, based on the second feedback information, whether there is an error in the image data transmitted by the target wireless communication link;
if there is an error in the image data transmitted by the target wireless communication link, the image data to be retransmitted is determined from the first portion of the image data based on the second feedback information;
suspending the encoded second portion of the image data sent to the terminal device over the rest of the wireless communication link and sending the image data to be retransmitted to the terminal device over the rest of the wireless communication link; and
after the image data to be retransmitted has been sent, the encoded second portion of the image data continues to be sent to the terminal device over the rest of the wireless communication link.

In an embodiment, the processor is configured to, in realizing the encoding of the image data captured by the movable platform according to the channel parameters and the sending of the encoded image data to the terminal device over the at least two wireless communication links:
determine a target wireless communication link with the best link quality from the at least two wireless communication links based on the channel parameter of each wireless communication link;
encode image data captured by the movable platform according to the channel parameter of the target wireless communication link; and
send the encoded image data to the terminal device simultaneously over the at least two wireless communication links.

In an embodiment, the processor is further configured to realize the following steps:
obtain third feedback information sent by the terminal device and determine, based on the third feedback information, whether there is an error in the image data transmitted by the target wireless communication link;
if there is an error in the image data transmitted by the target wireless communication link, the image data to be retransmitted is determined based on the third feedback information;
suspend the transmission of encoded image data to the terminal device over the rest of the wireless communication link;
send the image data to be retransmitted to the terminal device over the remaining wireless communication link; and
after the image data to be retransmitted has been sent, the encoded image data continues to be sent to the terminal device over the rest of the wireless communication link.

In an embodiment, the processor is further configured to realize the following steps:
obtaining a link quality trend of the target wireless communication link;
selecting a target channel bandwidth from channel bandwidths of the at least two wireless communication links based on the link quality trend;
encoding image data captured by the movable platform according to the target channel bandwidth; and
sending encoded image data to the terminal device simultaneously over the at least two wireless communication links.

In an embodiment, the processor is configured to perform the following, in realizing the selection of a target channel bandwidth from the channel bandwidths of the at least two wireless communication links based on the link quality trend:
if the link quality change trend does not satisfy a preset link quality degradation condition, the channel bandwidth of the target wireless communication link is determined as a target channel bandwidth;
if the link quality change trend satisfies a preset link quality degradation condition, the channel bandwidth of the remaining wireless communication links is determined as a target channel bandwidth.

In an embodiment, the link quality degradation condition comprises the degraded link quality gain being greater than a link quality degradation threshold.

In an embodiment, the processor is further configured to realize the following, before realizing the acquisition of channel parameters of at least two established wireless communication links:
obtaining the link quality of the established first wireless communication link; and
if the link quality of the first wireless communication link is less than or equal to a predetermined threshold, establishing the remaining wireless communication links between the movable platform and the terminal device, obtaining at least two wireless communication links.

In an embodiment, the processor is further configured to realize the following steps:
if the link quality of the first wireless communication link is greater than a preset threshold, the image data captured by the movable platform is encoded according to the channel parameter of the first wireless communication link; and
sending encoded image data to the terminal device over the first wireless communication link.

In an embodiment, the processor is further configured to realize the following steps:
if the link quality of the first wireless communication link changes from less than or equal to a predetermined threshold to greater than a predetermined threshold, disconnecting the remaining wireless communication links;
encoding image data captured by the movable platform according to channel parameters of the first wireless communication link; and
sending encoded image data to the terminal device over the first wireless communication link.

In an embodiment, the at least two wireless communication links comprise non-point-to-point wireless communication links, and the processor is further configured to implement the following steps:
obtaining a first fault-tolerant frame acquisition request sent by an intermediate node of the non-point-to-point wireless communication link;
according to the first error-tolerant frame acquisition request, performing intra-frame encoding on the image data captured by the movable platform to obtain an error-tolerant frame;
sending the error-tolerant frame to the terminal device over any one of the wireless communication links, or sending the error-tolerant frame to the terminal device over the wireless communication link with the best link quality, or sending the error-tolerant frame to the terminal device over at least two of the wireless communication links simultaneously.

In an embodiment, the non-point-to-point wireless communication link comprises at least one intermediate node.

In an embodiment, the processor is further configured to realize the following steps:
if a second fault-tolerant frame acquisition request sent by the terminal device is acquired, obtaining a first moment recorded by the movable platform receiving the first fault-tolerant frame acquisition request;
obtaining a second moment recorded by the movable platform receiving the second fault tolerant frame acquisition request and determining a reception time difference based on the first moment and the second moment; and
if the reception time difference is less than or equal to a preset time difference, no response is made to the second fault tolerant frame acquisition request.

It is to be noted that a person skilled in the field to which it belongs can clearly understand that, for the convenience and conciseness of the description, the specific working process of the above-described movable platform can be referred to the corresponding process in the foregoing embodiment of the wireless communication method, and will not be repeated herein.

Referring to FIG. 10, FIG. 10 is a schematic block diagram of a structure of a communication system provided by an embodiment of the present application. As shown in FIG. 10, the communication system 300 includes a movable platform 310 and a terminal device 320, the movable platform 310 and the terminal device 320 are capable of establishing at least two wireless communication links between the movable platform 310 and the terminal device 320, and the at least two wireless communication links are used for transmitting image data captured by the movable platform 310 to the terminal device 320.

It is to be noted that a person skilled in the field to which it belongs can clearly understand that, for the convenience and conciseness of the description, the specific working process of the communication system described above can be referred to the corresponding process in the foregoing embodiment of the wireless communication method, and will not be repeated herein.

Embodiments of the present application also provide a computer-readable storage medium, the computer-readable storage medium storing a computer program, the computer program comprising program instructions, the processor executing the program instructions to implement the steps of the wireless communication method provided in the embodiments.

The computer-readable storage medium may be an internal storage unit of the movable platform as described in any of the preceding embodiments, such as a hard disk or memory of the movable platform. The computer-readable storage medium may also be an external storage device of the movable platform, such as a plug-in hard disk equipped on the movable platform, a Smart Media Card (SMC), a Secure Digital (SD) card, a Flash Card, and the like. The storage medium may be a non-transitory storage medium.

It should be understood that the terminology used herein in this application specification is used solely for the purpose of describing particular embodiments and is not intended to limit this application. As used in this application specification and in the appended claims, the singular forms “one,” “a,” and “the” are intended to include the plural form unless the context clearly indicates otherwise. are intended to include the plural form.

It should also be understood that the term “and/or” as used in this application specification and the appended claims refers to and includes any combination and all possible combinations of one or more of the items listed in association.

The foregoing is only a specific embodiment of the present application, but the scope of protection of the present application is not limited thereto, and any person skilled in the art can easily think of various equivalent modifications or substitutions within the scope of the technology disclosed in the present application, which shall be covered by the scope of protection of the present application. Therefore, the scope of protection of this application shall be subject to the scope of protection of the claims.

The disclosure is illustrated above using the embodiments, but the technical scope of the disclosure is not limited to the scope described in the above embodiments. It is apparent to a person of ordinary skill in the art that various changes or improvements can be made to the above embodiments. It is obvious from the description of the claims that the manner in which such modifications or improvements are made may be included in the technical scope of the present disclosure.

It should be noted that the order of execution of actions, processes, steps, stages, and other treatments in the apparatus, system, program, and method shown in the claims, the specification, and the drawings accompanying the specification may be realized in any order as long as the words “before”, “in advance”, etc. are not specifically indicated. “, etc., and as long as the output of the preceding process is not used in the following process, the order of execution can be arbitrary. The flow of operations in the claims, the specification, and the drawings accompanying the specification are described for convenience by using the words “first,” “next,” etc., but this does not mean that they must be implemented in such an order.

The above mentioned is only a specific implementation of the present application, but the scope of protection of the present application is not limited to this, and any person skilled in the art can easily think of various equivalent modifications or substitutions within the technical scope disclosed in the present application, which should be covered by the scope of protection of the present application. Therefore, the scope of protection of this application shall be subject to the scope of protection of the claims.

What is claimed is:

1. A wireless communication method for a movable platform, comprising:
obtaining channel parameters of at least two wireless communication links established between the movable platform and a terminal device, the at least two wireless communication links comprising at least one public network communication link; and
encoding data captured by the movable platform according to the channel parameters and sending the encoded data to the terminal device over the at least two wireless communication links.

2. The wireless communication method according to claim 1, wherein the at least two wireless communication links further comprise at least one private network communication link, the public network communication link being a wireless communication link established based on public network communication, and the private network communication link being a wireless communication link established based on private communication.

3. The wireless communication method according to claim 1, wherein the at least two wireless communication links comprise a first public network communication link and a second public network communication link, and a network operator corresponding to the first public network communication link is different from a network operator corresponding to the second public network communication link.

4. The wireless communication method according to claim 1, wherein the at least two wireless communication links comprise a first wireless communication link and a second wireless communication link, and the channel parameters comprise a first channel parameter of the first wireless communication link and a second channel parameter of the second wireless communication link, and the encoding the data captured by the movable platform according to the channel parameters and sending the encoded data to the terminal device over the at least two wireless communication links comprises:
determining a target channel parameter from the first channel parameter and the second channel parameter;
encoding the data according to the target channel parameter to obtain target data; and
sending the target data to the terminal device over the at least two wireless communication links.

5. The wireless communication method according to claim 4, wherein the encoding the data according to the target channel parameter to obtain the target data comprises:
determining a target coding rate based on the target channel parameter; and
encoding the data according to the target coding rate to obtain the target data.

6. The wireless communication method according to claim 4, wherein the sending the target data to the terminal device over the at least two wireless communication links comprises:
performing a packetization process on the target data to obtaining a plurality of data packets; and
sending the plurality of data packets to the terminal device simultaneously over the first wireless communication link and the second wireless communication link.

7. The wireless communication method according to claim 4, wherein the sending the target data to the terminal device over the at least two wireless communication links comprises:
performing a packetization process on the target data to obtain a plurality of data packets; and
simultaneously sending a first portion of the plurality of data packets to the terminal device over the first wireless communication link and sending a second portion of the plurality of data packets other than the first portion of data packets to the terminal device over the second wireless communication link.

8. The wireless communication method according to claim 7, further comprising:
obtaining first feedback information sent by the terminal device;
determining that an error has occurred in one of the transmitted data packets based on the first feedback information; and
simultaneously sending the second portion of the data packets to the terminal device over the first wireless communication link and sending the first portion of the data packets to the terminal device over the second wireless communication link.

9. The wireless communication method according to claim 7, further comprising:
obtaining first feedback information sent by the terminal device;
determining that an error has occurred in one of the transmitted data packets based on the first feedback information, the one of the transmitted packets to be retransmitted is determined from the plurality of data packets based on the first feedback information;
under a condition that the one of the transmitted packets to be retransmitted is located in the first portion of the packet, retransmitting the one of the transmitted packets to be retransmitted to the terminal device over the second wireless communication link; and
under a condition that the one of the transmitted packets to be retransmitted is located in the second portion of the packet, retransmitting the one of the transmitted packets to be retransmitted to the terminal device over the first wireless communication link.

10. The wireless communication method according to claim 1, wherein the data comprises a first portion of data and a second portion of data, the encoding the data captured by the movable platform according to the channel parameters and sending the encoded data to the terminal device over the at least two wireless communication links comprises:
determining a target wireless communication link with the best link quality from the at least two wireless communication links based on the channel parameters of the at least two wireless communication links;
encoding the first portion of data according to a channel parameter of the target wireless communication link, and transmitting the encoded first portion of data to the terminal device over the target wireless communication link; and
encoding the second portion of data according to the channel parameters of the remaining wireless communication links, and transmitting the encoded second portion of data to the terminal device over the remaining wireless communication links.

11. The method of wireless communication according to claim 10, further comprising:
obtaining second feedback information sent by the terminal device;
determining, based on the second feedback information, that there is an error in a part of the data transmitted by the target wireless communication link, and the part of data to be retransmitted is determined from the first portion of the data based on the second feedback information;
suspending transmitting the encoded second portion of the data to the terminal device over the remaining wireless communication links and sending the part of data to be retransmitted to the terminal device over the remaining wireless communication links; and
after the part of data to be retransmitted has been sent, continue transmitting the encoded second portion of the data to the terminal device over the remaining wireless communication links.

12. The wireless communication method according to claim 1, wherein the encoding the data captured by the movable platform according to the channel parameters and sending the encoded data to the terminal device over the at least two wireless communication links comprises:
determining a target wireless communication link with the best link quality from the at least two wireless communication links based on the channel parameters of the at least two wireless communication links;
encoding the data captured by the movable platform according to a channel parameter of the target wireless communication link; and
sending the encoded data to the terminal device simultaneously over the at least two wireless communication links.

13. The wireless communication method according to claim 12, further comprising:
obtaining third feedback information sent by the terminal device;
determining, based on the third feedback information, that there is an error in a part of the data transmitted by the target wireless communication link;
suspending sending the encoded data to the terminal device over the remaining wireless communication links;
sending the part of the data to be retransmitted to the terminal device over the remaining wireless communication links; and
after the part of the data to be retransmitted has been sent, continue sending the encoded data to the terminal device over the remaining wireless communication links.

14. The wireless communication method according to claim 12, further comprising:
obtaining a link quality trend of the target wireless communication link;
selecting a target channel bandwidth from channel bandwidths of the at least two wireless communication links based on the link quality trend;
encoding the data captured by the movable platform according to the target channel bandwidth; and
sending the encoded data to the terminal device simultaneously over the at least two wireless communication links.

15. The wireless communication method according to claim 1, wherein the obtaining the channel parameters of the at least two established wireless communication links is preceded by:
obtaining link quality of an established first wireless communication link; and
under a condition that the link quality of the first wireless communication link is less than or equal to a preset threshold, establishing the remaining wireless communication links between the movable platform and the terminal device to obtain the at least two wireless communication links.

16. The wireless communication method according to claim 15, further comprising:
under a condition that the link quality of the first wireless communication link is greater than the preset threshold, encoding the data captured by the movable platform according to a channel parameter of the first wireless communication link; and
sending the encoded data to the terminal device over the first wireless communication link.

17. The method of wireless communication according to claim 15, further comprising:
under a condition that the link quality of the first wireless communication link changes from less than or equal to the preset threshold to greater than the preset threshold, disconnecting the remaining wireless communication links;
encoding the data captured by the movable platform according to a channel parameter of the first wireless communication link; and
sending the encoded data to the terminal device over the first wireless communication link.

18. The wireless communication method according to claim 1, wherein the at least two wireless communication links comprise a non-point-to-point wireless communication link, the method further comprising:
obtaining a first fault-tolerant frame acquisition request sent by an intermediate node of the non-point-to-point wireless communication link;
according to the first error-tolerant frame acquisition request, performing intra-frame encoding on the data captured by the movable platform to obtain an error-tolerant frame; and
sending the error-tolerant frame to the terminal device over any one of the wireless communication links, or sending the error-tolerant frame to the terminal device over the wireless communication link with the best link quality, or sending the error-tolerant frame to the terminal device over the at least two the wireless communication links simultaneously.

19. A movable platform, comprising:
at least two wireless communication structures, a memory and a processor;
the at least two wireless communication structures are configured to establish at least two wireless communication links between the movable platform and a terminal device;
the memory is configured to store a computer program;
the processor for executing the computer program and, in executing the computer program, implementing following steps:
obtaining channel parameters of the at least two wireless communication links, wherein the at least two wireless communication links comprise at least one public network communication link; and
encoding data captured by the movable platform according to the channel parameters and sending the encoded data to the terminal device over the at least two wireless communication links.
